(19) United States
(12) Patent Application Publication
(10) Pub. No.: US 2023/0160414 A1
(43) Pub. Date: May 25, 2023

(54) Eccentric anti-loosening screw device

(71) Applicant: Wen-Pin Huang, Kaohsiung (TW)

(72) Inventor: Wen-Pin Huang, Kaohsiung (TW)

(21) Appl. No.: 17/821,190

(22) Filed: Aug. 22, 2022

(51) Int. Cl. F16B 39/28

(52) U.S. Cl. CPC F16B 39/28

(57) ABSTRACT

An eccentric anti-loosening screw device includes a screw and a fastening assembly. The screw includes a head and a threaded shank. The fastening assembly is threadedly secured onto the shank and includes first and second locking members each including a longitudinal threaded hole secured onto the shank, and a surface of curved inclination on an end with the threaded hole passing through; and an angle of curved inclination is greater than a pitch of the shank. The surface of curved inclination of the first locking member is engaged with that of the second locking member to form a gap therebetween. Solder points fasten the first and second locking members together. A rotation of the first locking member about the second locking member fastens the first and second locking members together, and the second locking member is further rotated until the solder points are broken to generate an eccentric force.

### FIELD OF THE INVENTION

The invention relates to anti-loosening screws and more particularly to an eccentric anti-loosening screw device and method of manufacturing and installing same.

### BACKGROUND OF THE INVENTION

Typically, a workpiece fastened by a screw or bolt will not become loose if the workpiece is stationary. However, the screw may be loosened if the screw is in a vibration environment because the vibration may transmit to the screw.

It is known that great vibration occurs at many applications (e.g., running cars, pumps in us, running motorcycles, construction sites or the like). Taking running high-speed railroad cars as an example, screws of the train may loosen due to vibration. This is not safe.

Conventionally, two locking members are fastened together by adhesive. Further, the locking members are threadedly put on a screw. Next, one of the locking member at the farthest point of the object is clockwise rotated. Finally, a positioning pin is driven into a gap between the locking members. As a result, a workpiece is fastened by the locking members.

While the conventional art is good, continuing improvements of the art are constantly sought.

### SUMMARY OF THE INVENTION

It is therefore one object of the invention to provide an eccentric anti-loosening screw device comprising a screw and a fastening assembly wherein the screw includes a head and an externally threaded shank formed with the head; and the fastening assembly is threadedly secured onto the externally threaded shank and includes first and second locking members each including a longitudinal threaded hole threadedly secured onto the externally threaded shank, and a surface of curved inclination on an end with the threaded hole passing through; the surface of curved inclination is formed by spirally cutting based on an angle of curved inclination; and the angle of curved inclination is greater than a pitch of the externally threaded shank; and the surface of curved inclination of the first locking member is engaged with that of the second locking member to form a gap therebetween; one of more solder points are used to temporarily fasten the first and second locking members together; a rotation of the first locking member about the second locking member fastens the first and second locking members together, the second locking member is further rotated until the solder points are broken so that an eccentric force is generated for fastening the first and second locking members together.

It is another object of the invention to provide a method of manufacturing and installing an eccentric anti-loosening screw device comprising the steps of drilling wherein a hole is drilled through a central portion of an elongated, multi-sided member, and a diameter of the hole is about the same as that of the shank; cutting wherein a middle portion of the multi-sided member is spirally cut to form a surface of curved inclination, an angle of curved inclination is greater than a pitch of the shank to form two locking members; fixing wherein a middle portion the surface of curved inclinations of the locking members are engaged prior to rotating with respect to each other, a gap is formed between the locking members, a plurality of solder points are formed to temporarily fasten the locking members together, and an opening angle of the gap is calculated from a center of a circle; threads forming wherein a thread forming machine is used to form threads on an inner surface of the hole until a threaded hole is formed in each locking member, and the locking members form the fastening assembly which is threadedly secured onto the threaded shank; and installing wherein a screw is screwed through a workpiece to be fastened, the fastening assembly is threadedly put on the shank of the screw, a tool is clockwise rotated to turn a second locking member, the fastening assembly rotates to fasten the workpiece, the tool is clockwise rotated to turn the second locking member until the solder points are broken and the gap is increased, and an eccentric force is generated at a joining surface of a first locking member and the second locking member and it is exerted on the workpiece to fasten them together.

The invention has the following advantages and benefits in comparison with the conventional art:

Anti-loosening. An angle of curved inclination is greater than a pitch of the threaded shank to provide a reliable fastening. The fastening assembly is used to position a workpiece, then the two locking members are used to fasten the workpiece, and next a tool is used to fasten the curved inclinations which are in turn exert an eccentric force on the locking members. Finally, the workpiece, the screw and the locking members are fastened together.

Convenient operation. The threads forming step makes female threads of the locking member to be consistent each other. And in turn, it makes fastening more convenient. The locking members of the fastening assembly are threadedly fastened together. As a result, there is no problem of the locking members being separated.

Manufacturing cost reduction. More than two different locking members are required by the conventional art in the fastening. Thus, different molds are required in the manufacturing process. In contrast, the invention uses the same locking members, uses the angle of curved inclination of the locking member, and uses the complying pitch of the threaded shank, thereby achieving the purpose of fastening. A single mold is used in the mass production and thus the manufacturing cost is decreased greatly.

The above and other objects, features and advantages of the invention will become apparent from the following detailed description taken with the accompanying drawings

### BRIEF DESCRIPTION OF THE DRAWINGS

FIG. 1 is a perspective view of an eccentric anti-loosening screw device of the invention with a fastened workpiece;

FIG. 2 is a perspective view of the locking member;

FIG. 3 is a flowchart of a method of manufacturing and installing an eccentric anti-loosening screw device of the invention;

FIG. 4 is a perspective view of an elongated, multi-sided member used in the drilling step;

FIG. 5 is a perspective view of the elongated, multi-sided member with two locking members being formed initially in the cutting step;

FIG. 6 is a perspective vie of the locking member;

FIG. 7 is a side elevation in part section of the screw and the two locking members in the final sub-step of the cutting step;

FIG. 8 is a perspective view of the two locking members being temporarily fastened together by a plurality of solder points in the fixing step;

FIG. 9 is a perspective view of the formed locking member in the final sub-step of the fixing step;

FIG. 10 is a perspective view of the two locking members being temporarily fastened together by solder points in the threads forming step;

FIG. 11 is a view similar to FIG. 10 where the gap is increased in the final-sub-step of the threads forming step;

FIG. 12 is a side elevation of the workpiece, the screw, the two locking members and a tool used in the installing step;

FIG. 13 is a perspective view of FIG. 12;

FIG. 14 is a perspective view of the tool; and

FIG. 15 is a longitudinal sectional view of the tool.

### DETAILED DESCRIPTION OF THE INVENTION

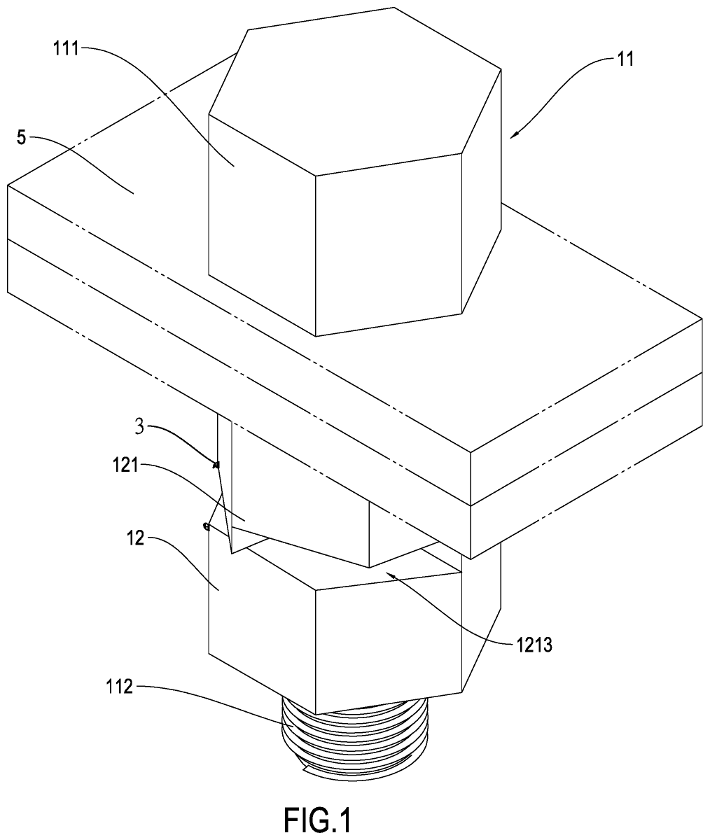

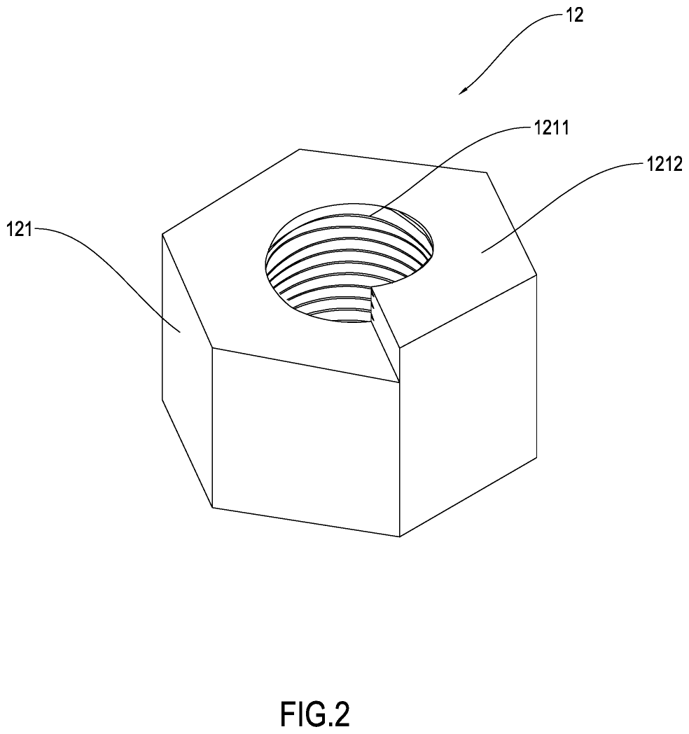

Referring to FIGS. 1 to 2, an eccentric anti-loosening screw device of the invention comprises a screw 11 and a fastening assembly 12 as discussed in detail below.

The screw 11 includes a head 11 and a threaded shank 112 formed with the head 11. The fastening assembly 12 is threadedly secured onto the shank 112 and includes two locking members 121. The locking member 121 includes a longitudinal threaded hole 1211 threadedly secured onto the shank 112, and a surface of curved inclination 121 on one end with the threaded hole 1211 passing through its center.

The surface of curved inclination 1212 of one locking member 121 is engaged with that of the other locking member 121 to form a gap 1213 between them. One or more solder points 3 are used to temporarily fasten the locking members 121 together. Next, rotating one locking member 121 about the other locking member 121 until the solder points are broken. An eccentric force is exerted on a workpiece 5 by the fastening assembly 12. As a result, the workpiece 5 is fastened between the fastening assembly 12 and the head 111 of the screw 11.

An opening angle of the gap 1213 is calculated from a center of a circle. Preferably, the angle is between 0-120 degrees. The locking members 121 can be secured together within this angle range. Further, there is no interlocking in rotation.

Preferably, the number of the solder points 3 is at least one. The more of the number of the solder points 3 the fastening of the locking members 121 is more reliable. Thus, more force is required to break the solder points 3.

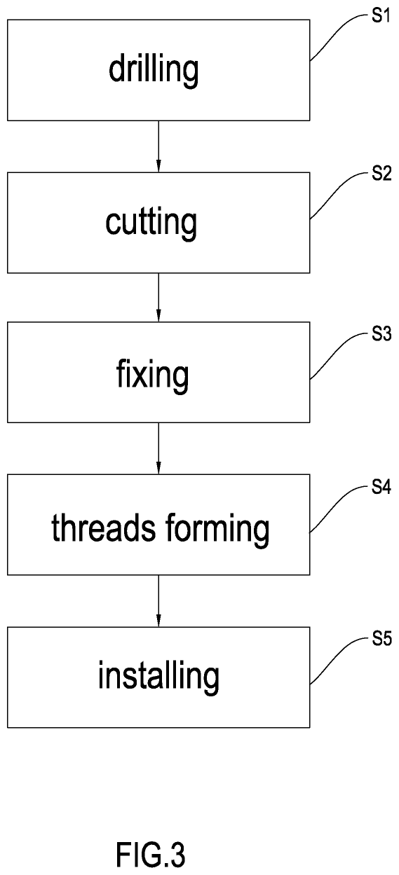

Referring to FIG. 3, a method of manufacturing and installing an eccentric anti-loosening screw device of the invention is illustrated.

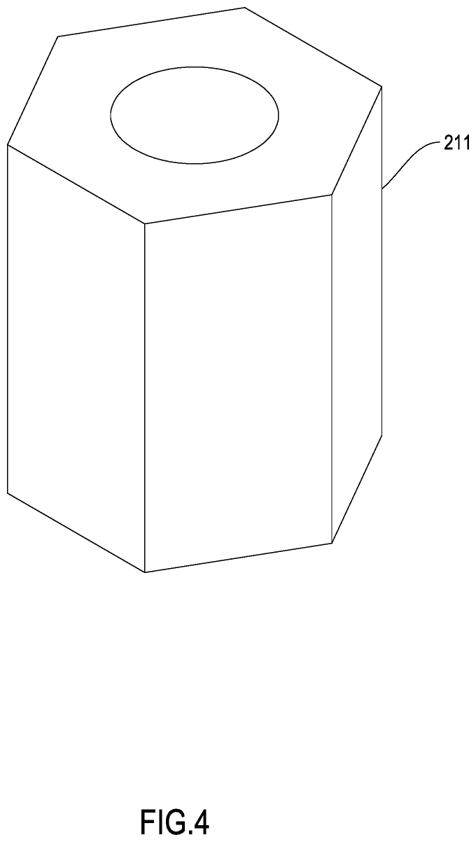

Referring to FIG. 4 in conjunction with FIG. 3, in a drilling step S1 a hole is drilled through a central portion of an elongated, multi-sided member 211. A diameter of the hole is about the same as that of the shank 112. The number of the sides of the member 211 is four or six. Alternatively, the member 211 is a cylinder.

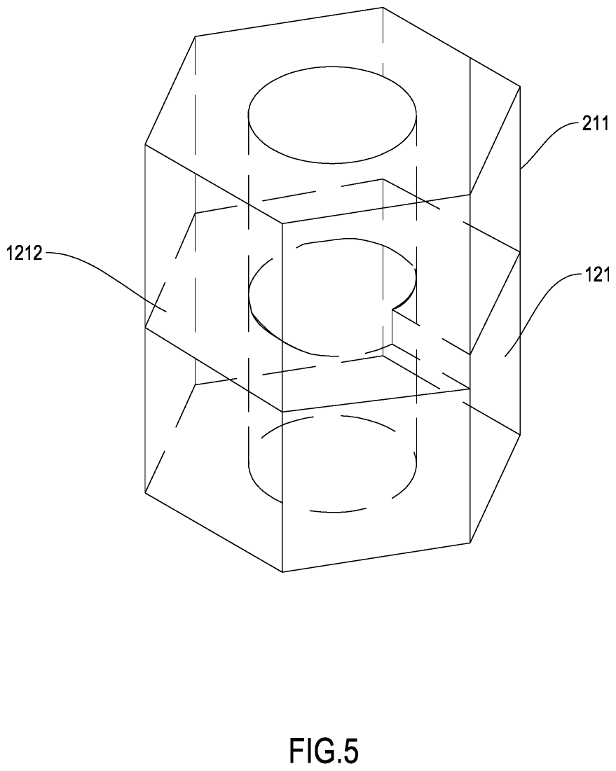

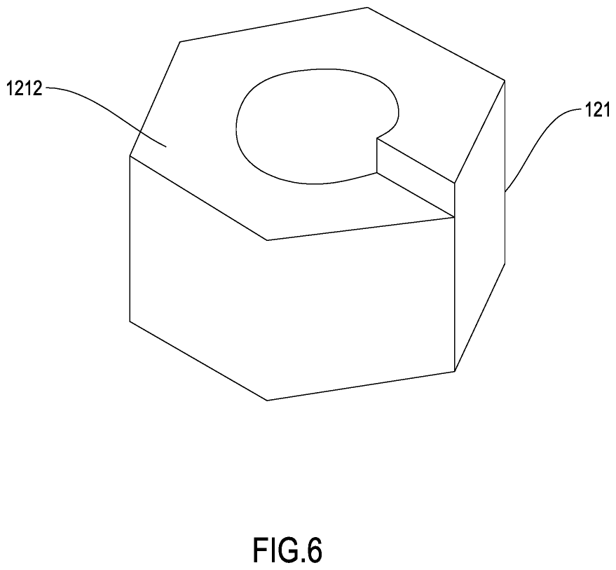

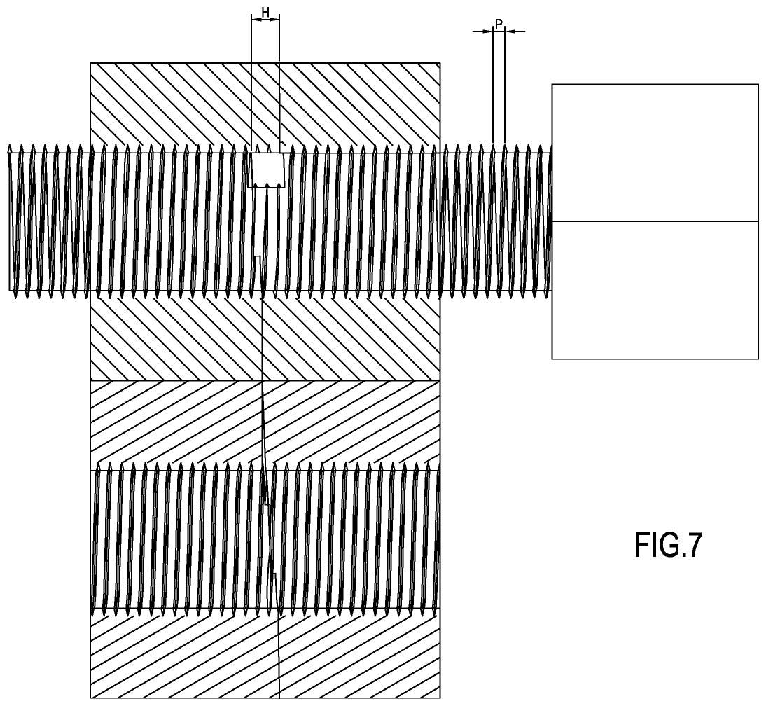

Referring to FIGS. 5, 6 and 7 in conjunction with FIG. 3, in a cutting step S2 a middle portion of the multi-sided member 211 is spirally cut to form a surface of curved inclination 1212. An angle of curved inclination H is greater than a pitch P of the shank 112 so as to form two locking members 121 (see FIGS. 5 and 7). Alternatively, an edge of the multi-sided member 211 is spirally cut to form a surface of curved inclination 1212 based on the angle of curved inclination. The angle of curved inclination H is greater than the pitch P of the shank 112 so as to form a single locking member 121 (see FIGS. 6 and 7). The cutting of the multi-sided member 211 is done by a linear cutting machine, a cutter, or a laser cutting machine.

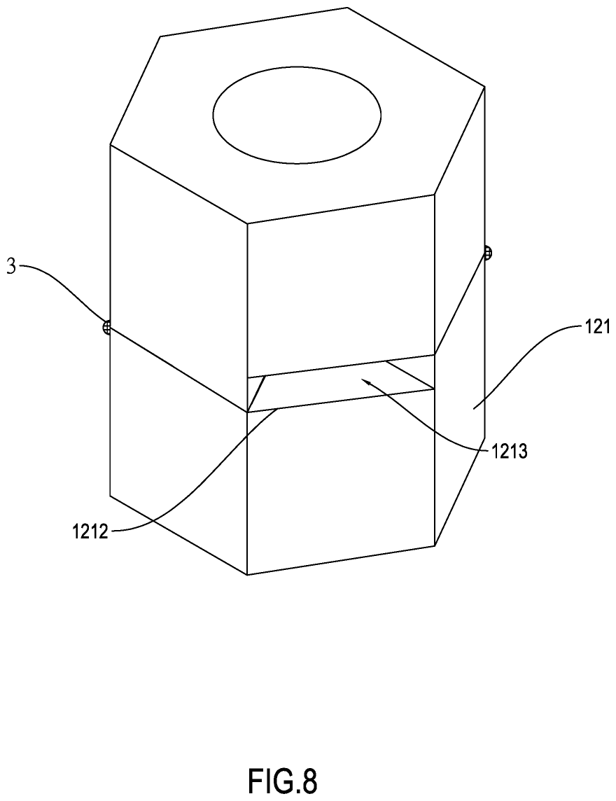

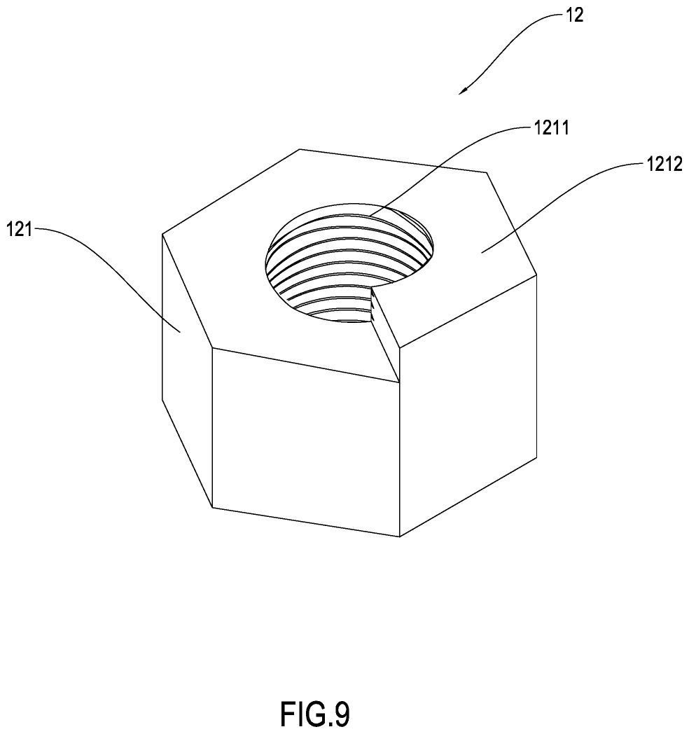

Referring to FIGS. 8 and 9 in conjunction with FIG. 3, in a fixing step S3 a middle portion the surface of curved inclinations 1212 of the two locking members 121 are engaged prior to rotating with respect to each other. Thus, a gap 1213 is formed between the locking members 121. A plurality of solder points 3 are formed by spot soldering to temporarily fasten the locking members 121 together. An opening angle of the gap 1213 is calculated from a center of a circle. Preferably, the angle is between 0-120 degrees.

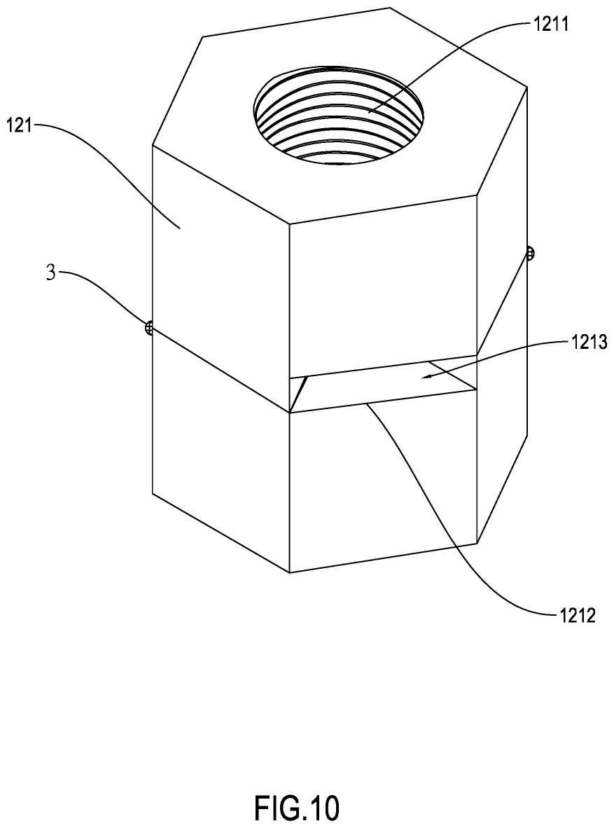

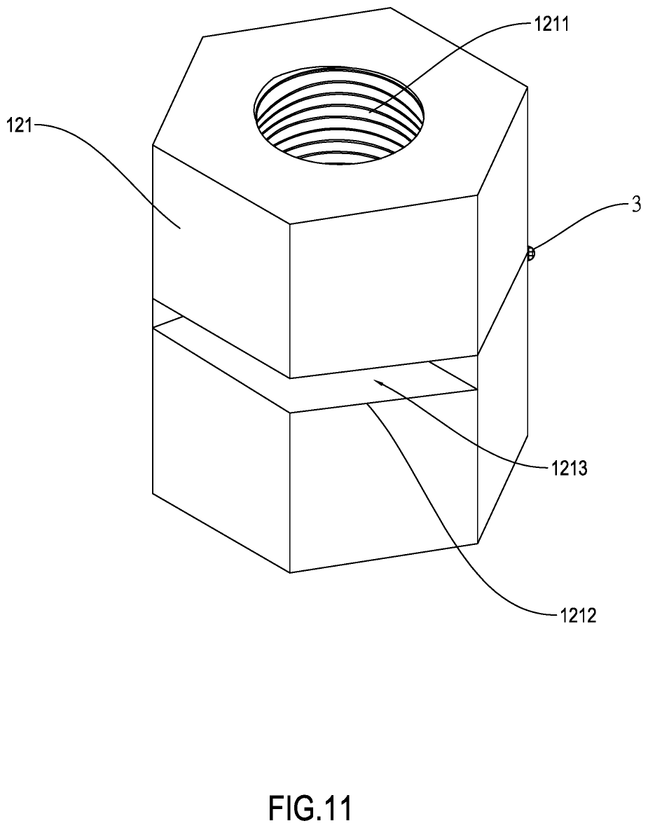

Referring to FIGS. 10 and 11 in conjunction with FIG. 3, in a threads forming step S4 a thread forming machine is used to form threads on an inner surface of the hole until a threaded hole 121 is formed in each locking member 121. The two locking members 121 form the fastening assembly 12 which is threadedly secured onto the threaded shank 112.

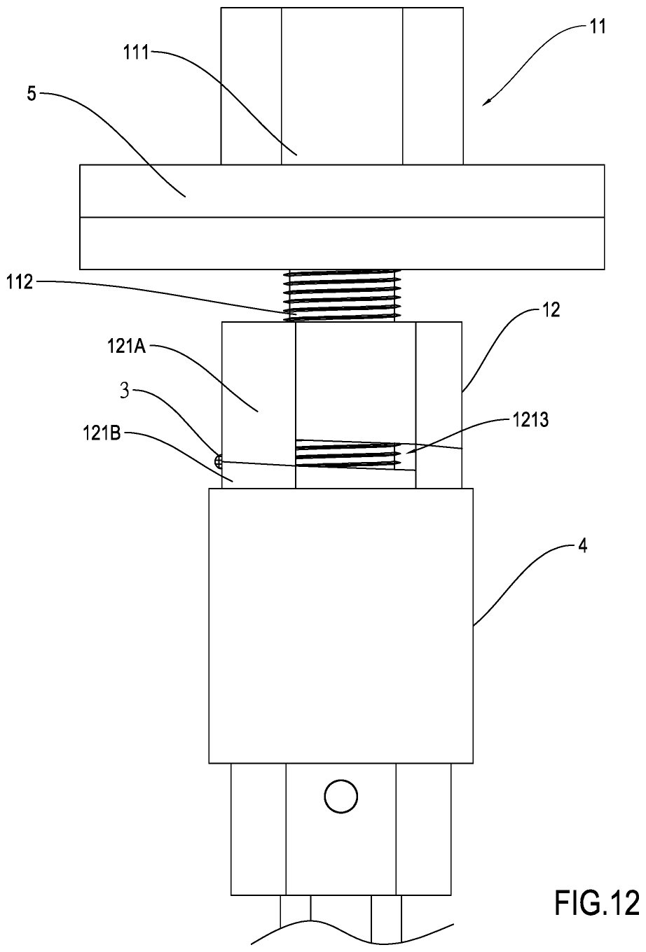

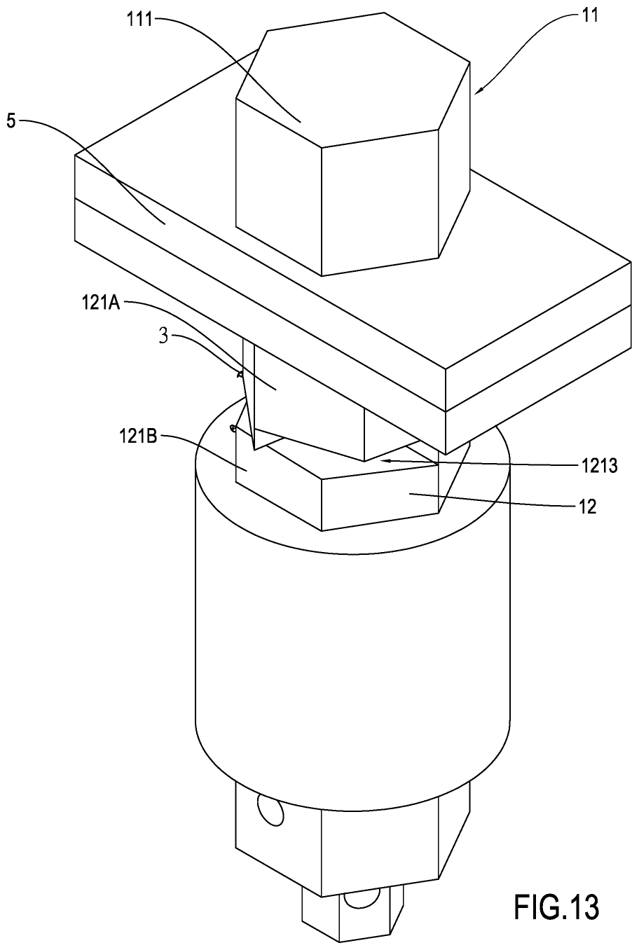

Referring to FIGS. 12 and 13 in conjunction with FIG. 3, a first locking member 121A and a second locking member 121B are provided for clarity of illustration. In an installing step S5 a screw 11 is screwed through a workpiece 5 to be fastened. Next, the fastening assembly 12 is threadedly put on the shank 112 of the screw 11. Next, a tool 4 is clockwise rotated to turn the second locking member 121B. And in turn, the fastening assembly 12 rotates to fasten the workpiece 5. Next, the tool 4 is clockwise rotated to turn the second locking member 121B until the solder points 3 are broken and the gap 1213 is increased. An eccentric force is generated at a joining surface of the first locking member 121A and the second locking member 121B and it is exerted on the workpiece 5 to fasten them together.

In short, for fastening a workpiece 5, the screw 22 is driven through the workpiece 5. Next, a tool 4 is used to threadedly put the fastening assembly 12 onto the shank 112. The tool 4 is used to turn the second locking member 121B to break the solder points. The gap 1213 between the locking members 121A and 121B is increased. An eccentric force is generated at a joining surface of the first locking member 121A and the second locking member 121B and it is exerted on the workpiece 5 to fasten them together.

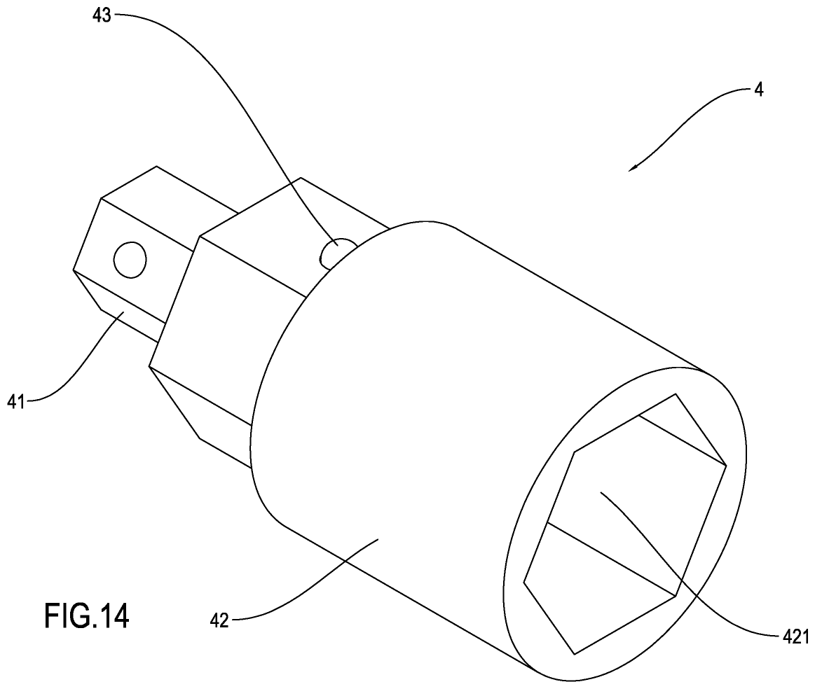

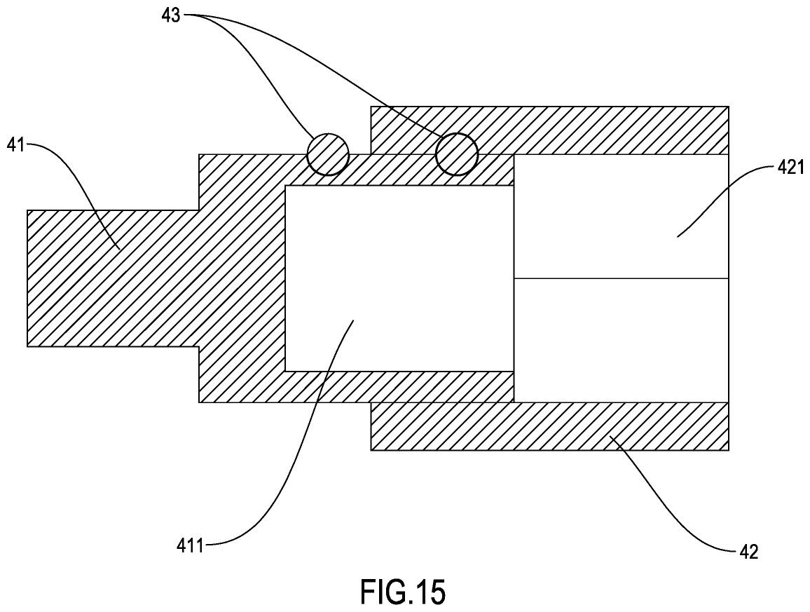

Referring to FIGS. 14 and 15 in conjunction with FIGS. 12 and 13, in the installing step S5 the tool 4 includes a coupling member 41 for attaching to a portable electric tool, a sleeve 42 moveably put on the coupling member 41, and a plurality of steel balls 43 rotatably disposed on an outer surface of the coupling member 41 for positioning the sleeve 42. An axial through channel 421 is formed in the sleeve 42 for complementarily receiving the locking member 121. A depth of the channel 421 is more than a total depth of the two locking members 121. The tool 4 pushes the sleeve 42 in the installing step S5 until the two locking members 121 are received in the channel 421. Further, in a next fastening step the sleeve 42 is pulled until only one locking member 121 is received in the channel 421. Also, a hole 411 of the coupling member 41 is configured to allow the shank 112 to extend thereinto.

The invention has the following advantages and benefits in comparison with the conventional art:

Anti-loosening. An angle of curved inclination is greater than a pitch of the threaded shank to provide a reliable fastening. The fastening assembly is used to position a workpiece, then the two locking members are used to fasten the workpiece, and next a tool is used to fasten the curved inclinations which are in turn exert an eccentric force on the locking members. Finally, the workpiece, the screw and the locking members are fastened together.

Convenient operation. The threads forming step makes female threads of the locking member to be consistent each other. And in turn, it makes fastening more convenient. The locking members of the fastening assembly are threadedly fastened together. As a result, there is no problem of the locking members being separated.

Manufacturing cost reduction. More than two different locking members are required by the conventional art in the fastening. Thus, different molds are required in the manufacturing process. In contrast, the invention uses the same locking members, uses the angle of curved inclination of the locking member, and uses the complying pitch of the threaded shank, thereby achieving the purpose of fastening. A single mold is used in the mass production and thus the manufacturing cost is decreased greatly.

While the invention has been described in terms of preferred embodiments, those skilled in the art will recognize that the invention can be practiced with modifications within the spirit and scope of the appended claims.

What is claimed is:

1. An eccentric anti-loosening screw device comprising a screw and a fastening assembly wherein:
the screw includes a head and an externally threaded shank formed with the head; and
the fastening assembly is threadedly secured onto the externally threaded shank and includes first and second locking members each including a longitudinal threaded hole threadedly secured onto the externally threaded shank, and a surface of curved inclination on an end with the threaded hole passing through; the surface of curved inclination is formed by spirally cutting based on an angle of curved inclination; and the angle of curved inclination is greater than a pitch of the externally threaded shank; and
the surface of curved inclination of the first locking member is engaged with that of the second locking member to form a gap therebetween; one of more solder points are used to temporarily fasten the first and second locking members together; a rotation of the first locking member about the second locking member fastens the first and second locking members together, and the second locking member is further rotated until the solder points are broken so that an eccentric force is generated for fastening the first and second locking members together.

2. The eccentric anti-loosening screw device of claim 1, wherein an opening angle of the gap between the first locking member and the second locking member is calculated from a center of a circle, and the opening angle of the gap is between 0-120 degrees.

3. The eccentric anti-loosening screw device of claim 1, wherein the number of the solder point is at least one.

4. A method of manufacturing and installing an eccentric anti-loosening screw device comprising the steps of:
drilling wherein a hole is drilled through a central portion of an elongated, multi-sided member, and a diameter of the hole is about the same as that of the shank;
cutting wherein a middle portion of the multi-sided member is spirally cut to form a surface of curved inclination, an angle of curved inclination is greater than a pitch of the shank to form two locking members;
fixing wherein a middle portion the surface of curved inclinations of the locking members are engaged prior to rotating with respect to each other, a gap is formed between the locking members, a plurality of solder points are formed to temporarily fasten the locking members together, and an opening angle of the gap is calculated from a center of a circle;
threads forming wherein a thread forming machine is used to form threads on an inner surface of the hole until a threaded hole is formed in each locking member, and the locking members form the fastening assembly which is threadedly secured onto the threaded shank; and
installing wherein a screw is screwed through a workpiece to be fastened, the fastening assembly is threadedly put on the shank of the screw, a tool is clockwise rotated to turn a second locking member, the fastening assembly rotates to fasten the workpiece, the tool is clockwise rotated to turn the second locking member until the solder points are broken and the gap is increased, and an eccentric force is generated at a joining surface of a first locking member and the second locking member and it is exerted on the workpiece to fasten them together.

5. The method of claim 4, wherein an opening angle of the gap between the first locking member and the second locking member is calculated from a center of a circle, and the opening angle of the gap is between 0-120 degrees.
